(19) United States
(12) Patent Application Publication
(10) Pub. No.: US 2026/0119370 A1
(43) Pub. Date: Apr. 30, 2026

(54) INFRASTRUCTURE-AS-CODE SERVICE FOR AUTOMATIC SUPPORT OF ARBITRARY USER SPECIFIED INPUT

(71) Applicant: Hewlett Packard Enterprise Development LP, Spring, TX (US)

(72) Inventors: Stuart Alexander McLaren, Galway (IE); Aisling Heanue, Galway (IE); Piotr Debicki, Staten Island, NY (US)

(21) Appl. No.: 18/933,890

(22) Filed: Oct. 31, 2024

(51) Int. Cl. G06F 11/36

(52) U.S. Cl. CPC G06F 11/3608

(57) ABSTRACT

In certain examples, a method includes obtaining, by a cloud infrastructure template generator, a location of IaC code for provisioning computing infrastructure; assessing, by the cloud infrastructure template generator, the IaC code to determine whether the IaC code includes any input parameters to be used during execution of the IaC code; generating, by the cloud infrastructure template generator and when input parameters exist, a schema for the IaC code based on the input parameters; storing the schema as a portion of a cloud infrastructure template; receiving a selection of the cloud infrastructure template; providing prompts for the user to provide the input parameters; performing a validation of the input parameters entered by the user; and providing, after the validation is successful, the input parameters to the IaC code, wherein the IaC code is executed using the input parameters to provision the computing infrastructure.

### BACKGROUND

Entities often seek computing resources to perform tasks, execute operations, host applications, provide services, and the like. Accordingly, such entities may seek access to computing infrastructure that provides such computing resources. Computing infrastructure may include physical hardware (e.g., computing devices, network devices, storage devices, and the like) and/or software resources (e.g., virtual machines, containers, container pods, other virtual infrastructure components, and the like).

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims. Aspects of the present disclosure are best understood from the following detailed description when read with the accompanying figures. For a more complete understanding of this disclosure, and advantages thereof, reference is now made to the following descriptions taken in conjunction with the accompanying drawings, in which:

FIG. 1 shows a block diagram of a system for providing an Infrastructure-as-Code (IaC) service for automatic support of arbitrary user-specified input in accordance with one or more examples disclosed herein;

FIG. 2 shows an example of a web-based UI generated based on a cloud infrastructure template in accordance with one or more examples disclosed herein;

FIG. 3 illustrates an overview of an example method for automatically generating schema for a cloud infrastructure template based on IaC code, in accordance with to one or more examples disclosed herein;

FIG. 4 illustrates a block diagram of a computing device, in accordance with one or more examples disclosed herein; and

FIG. 5 illustrates a block diagram of a computing device, in accordance with one or more examples disclosed herein.

The figures are drawn to illustrate various aspects of the disclosure and are not necessarily drawn to scale.

### DESCRIPTION

The following disclosure provides many different examples for implementing different features. Specific examples of components and arrangements are described below to simplify the present disclosure. These are, of course, merely examples and are not intended to be limiting.

Computing infrastructure, such as physical hardware (e.g., computing devices, network devices, storage devices, and the like) and/or software resources (e.g., virtual machines, containers, container pods, other virtual infrastructure components, and the like), is often sought for various purposes. In one or more examples, computing infrastructure may be provided (e.g., from a cloud services provider) as a service (e.g., Infrastructure-as-a-Service (IaaS)). Such infrastructure, to be useful, is often configured to meet the needs of an entity (e.g., customer) seeking to use the computing infrastructure. Such configuration may include the provisioning of computing resources to form the desired infrastructure.

Provisioning of computing infrastructure may, at least in part, be provided, as an example, using Infrastructure-as-Code (IaC) technologies, which may allow for controlled, automated, consistent, and reusable techniques for infrastructure provisioning. Various IaC tools (e.g., Terraform, Ansible, and the like) exist for consuming code that, when executed, performs provisioning of computing resources to form desired computing infrastructure. As an example, an entity seeking access to computing resources may seek such resources from a provider of cloud computing resources (e.g., a cloud services provider), and IaC tools may be used to configure the infrastructure sought by the entity within the computing resources maintained by the cloud services provider. IaC code may, for example, interact with various application programing interfaces (APIs) to configure computing resources into desired computing infrastructure.

However, configuration of computing resources into desired infrastructure using IaC tools often requires significant expertise in one or more IaC tools, which may not be available to entities seeking such infrastructure. Moreover, even if a more simplified interface were to be provided to users for specifying (e.g., providing input parameters) various aspects of computing infrastructure, which could then be used to deploy such infrastructure, the interface would have to account for differences in various IaC tools, comprehend the complexity inherent in defining computer infrastructure, be configured to possibly perform complex validations, and the like.

One or more examples disclosed herein address, at least in part, the challenges discussed above of using IaC tools for provisioning computing infrastructure by providing techniques by which IaC code for provisioning computing infrastructure may be written, and any such code may be automatically assessed to determine the various user input parameters needed to execute the IaC code. In one or more examples, once the IaC code input parameters are assessed, metadata related to the input parameters may be automatically generated and stored in a common format, which may be used as part of a template, which may be used to present a form (e.g., via an API or other user interface (UI)) to a user seeking to configure computing infrastructure. Thus, in one or more examples, a user seeking computing infrastructure, without specific knowledge of IaC techniques, can be guided to enter input parameters and related information, which may then be used as input to the IaC code from which a schema of the template was generated in order to provision computing infrastructure.

In one or more examples, IaC code is generated for configuring all or any portion of a set of computing resources as computing infrastructure to be made available to an entity seeking such computing infrastructure. The IaC code may be newly generated (e.g., written by an IaC code author), or otherwise obtained (e.g., from a body of existing IaC code for performing various provisioning tasks). As an example, IaC code may be generated or obtained for provisioning one or more virtual machines and related virtual infrastructure, a container ecosystem, physical hardware resources, and/or any other relevant computing infrastructure. Such IaC code may be stored, for example, in an IaC repository (e.g., a git repository), any number of such repositories, and/or any number of directories within such repositories.

In one or more examples, to make such IaC code available to be used in the service of providing computing infrastructure, the IaC code author, or other entity seeking to allow use of IaC code (e.g., a template author), may access a user interface (e.g., an API or a graphical UI (GUI)) of a cloud infrastructure provider tool, and initiate generation of a cloud infrastructure template (e.g., via a cloud infrastructure template generator). In one or more examples, a cloud infrastructure template includes a set of input parameter metadata related to the input parameters needed by the IaC code for execution. In one or more examples, the entity seeking to create the template may provide to the cloud infrastructure template generator a location where the IaC code is stored (e.g., path(s) to one or more git repositories).

In one or more examples, the cloud infrastructure template generator, in response to the initiation of template creation, may access the IaC code in the one or more repositories, and assess the IaC code to determine input parameter metadata (e.g., parameter name, information related to parameter, parameter type, one or more values required to complete parameter, and the like) related to input parameters needed to execute the IaC code, including information that is to be supplied by the entity seeking provisioning of computing infrastructure. In one or more examples, the cloud infrastructure template generator generates a schema that represents the input parameter metadata for the input parameters, and related information, needed to execute the IaC code. As an example, a portion of the schema may include that an integer value should be entered as an input parameter, and that a constraint exists that the integer value should be between one and one hundred. As another example, a portion of the schema may include that an input parameter value should be a string, and that a constraint exists that the string should be less than 128 characters. As an example, the cloud infrastructure template generator may generate a JavaScript Object Notation (JSON) schema definition that includes information related to the various input parameters. In one or more examples, the schema created based on the IaC code input parameters may be a portion of a cloud infrastructure template. In one or more examples, in addition to a schema, a cloud infrastructure template may include other information, such as a link to the IaC code, a name of the template, permissions (e.g., user and/or access permissions) related to the template, metadata specifying the IaC tool the template should be used by (e.g., Terraform), and the like. Such a cloud infrastructure template may be stored in a cloud infrastructure template storage device for future use when provisioning computing infrastructure.

In one or more examples, the cloud infrastructure template may then be used to provision computing infrastructure. As an example, a user may access an API or UI provided by a cloud infrastructure provider (e.g., as part of a cloud infrastructure provider tool), seeking to provision computing infrastructure for any purpose. Such a user may browse a set of available cloud infrastructure templates (e.g., deploy a virtual machine, create a container ecosystem, configure one or more servers for a particular purpose, and the like) stored in a cloud infrastructure template storage device.

In one or more examples, the user then selects a template to use. In one or more examples, the cloud infrastructure provider tool may then access the schema associated with the cloud infrastructure template, and provide, based on the schema, prompts to the user to enter information related to the input parameters needed to provision computing infrastructure using the IaC code associated with the cloud infrastructure template. As an example, when the user is using a web-based UI, the prompts may be presented as a form within the UI. As another example, when the user selects a template via an API, non-graphical prompts may be provided to the user for entering input parameters and related information.

As an example, the user may be prompted to provide a name for the configuration, and various parameters related to the infrastructure to be provisioned. For example, a user seeking to provision a set of virtual machines may be prompted to provide a quantity of virtual machines, various configuration details related to the virtual machines (e.g., number of processors, amount of memory, and the like), and any other information relevant to such parameters, such as a type (e.g., string, list, dictionary, set, tuple, map, object, number, bool, combinations of such types, and the like), various constraints, and the like. In some examples, (e.g., when a user is using a web-based UI) certain input parameters may have pre-defined default values in the corresponding IaC code, which are captured in the cloud infrastructure template, and which a user may be given the option to accept or modify.

In one or more examples, the schema includes acceptable input parameter values for fields that the user is expected to input, and may be configured to alert the user if an input does not conform to input values expected pursuant to the validation that will be performed based on the schema, which may be considered as a form of preliminary validation. Such an alert may take any form capable of conveying information to a user, regardless of whether the user is interacting with an API or a UI. As an example, a given field for entering an input parameter may have defined in the schema that only numbers in a certain range are acceptable, that only string input types are acceptable, or that only a certain set of words are acceptable (e.g., one of seven days of the week). In one or more examples, input parameter values may be checked against the expected input values defined in the schema in real-time or near real time as the input parameters are entered by the user, thereby providing an initial validation of the input parameters provided by the user. In one or more examples, when the validation is not successful (e.g., an entered input parameter does not conform to the expected input parameter values/constraints), the cloud infrastructure provider tool may provide an alert to the user of that fact, and may also provide information related to the expected input values, after which the user may re-enter the input parameter. As an example, a user entering input parameter values using a web-based UI may, when an unacceptable value is input, be presented with a pop-up that indicates that the value is unacceptable, and may also include information regarding what values are acceptable for the input parameter.

In one or more examples, once a user has entered each input parameter defined in the cloud infrastructure template, and/or accepted default values for such parameters, the user may provide an indication (e.g., hit a button) to initiate provisioning of computing infrastructure based on the template. In one or more examples, the set of user input parameters are then put into a usable file format (e.g., a JSON file), and may be subjected to an additional validation check that re-verifies that the input parameters conform to the expected input parameters needed to execute the IaC code associated with the cloud infrastructure template. In one or more examples, the file is provided as input to the IaC code, which is then executed using the file, and the input parameter values and related information therein, to provision computing infrastructure.

In one or more examples, generating cloud infrastructure templates as discussed above may reduce or eliminate the need for IaC code authors to create mappings between input parameters for the IaC code and cloud service tools provided to users for using the IaC tools to provision computing infrastructure, allow for simplified re-use of IaC code, allow for preservation of type information for input parameters, allow for simplified use by APIs and/or UIs that are provided to users seeking to provision cloud infrastructure of the cloud infrastructure template to prompt the users to enter user input parameters, and allow for simplified validation of input parameters entered by such users. Additionally, using a common format for the schema (e.g., a JSON schema format) generated based on IaC code may be independent of the IaC tool being used, which may allow for efficiencies through using standard libraries associated with the common format both for validation and for presenting prompts to the user via a UI and/or API.

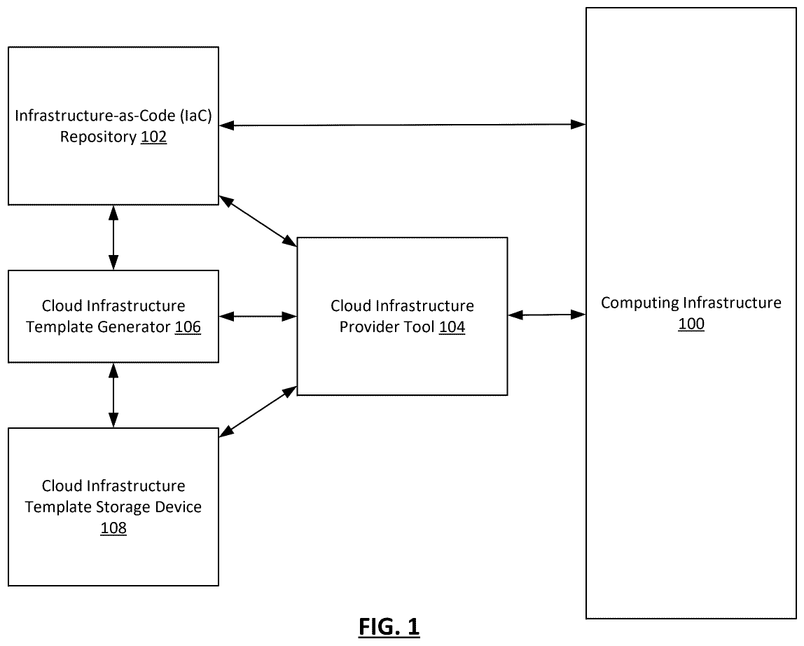

FIG. 1 shows a block diagram of a system for providing an IaC service for automatic support of arbitrary user-specified input in accordance with one or more examples disclosed herein. As shown in FIG. 1, the system may include computing infrastructure 100, a cloud infrastructure provider tool 104, an IaC repository 102, a cloud infrastructure template generator 106, and a cloud infrastructure template storage device. Each of these components is described below.

In one or more examples, the computing infrastructure 100 is a set of computing resources. Such resources may be owned, operated, or otherwise maintained, as an example, by a cloud services provider that makes the computing resources available to customers, users, and the like to be configured as any number of instances of computing infrastructure. The computing infrastructure 100 may include any amount of hardware computing resources (e.g., computing devices, storage devices, network devices), software computing resources (e.g., operating systems, network software, application software, system software, management software, virtualized computing resources (e.g., virtual machines, virtual network devices, virtual storage devices, containers, container pods, and the like), other hardware components (e.g., power supplies, racks, cooling systems, and the like). The computer infrastructure may be in a single physical location (e.g., site) or distributed among any number of physical locations. The computing infrastructure 100 may, as an example, be located in one or more data centers.

In one or more examples, the computing infrastructure 100 includes and/or is operatively connected to the cloud infrastructure provider tool 104. In one or more examples, the cloud infrastructure provider tool 104 is a set of computing resources that are configured to interact with the computing infrastructure to provision portions therein as computing infrastructure to be made available to users as needed. To that end, the cloud infrastructure provider tool 104 may be configured to interact with the IaC repository (discussed below), execute or cause execution of IaC code from the IaC repository to provision computing infrastructure (e.g., the computing infrastructure 100), interact with a cloud infrastructure template generator (discussed below) to generate, maintain, and use cloud infrastructure templates (discussed below), and to have access to cloud infrastructure templates stored in a cloud infrastructure template storage device (e.g., the cloud infrastructure template storage device 108, discussed below).

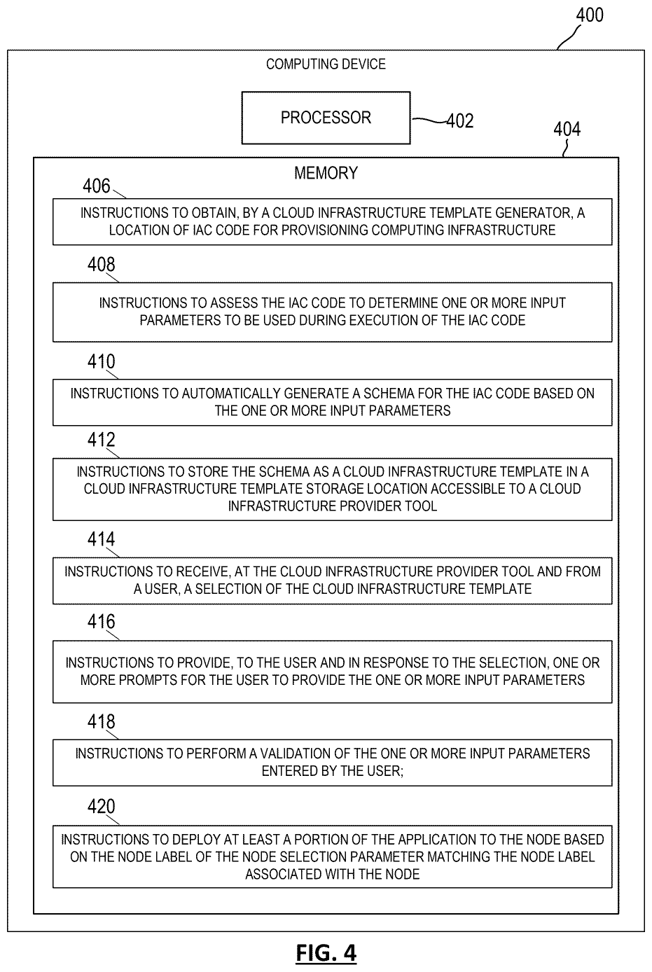

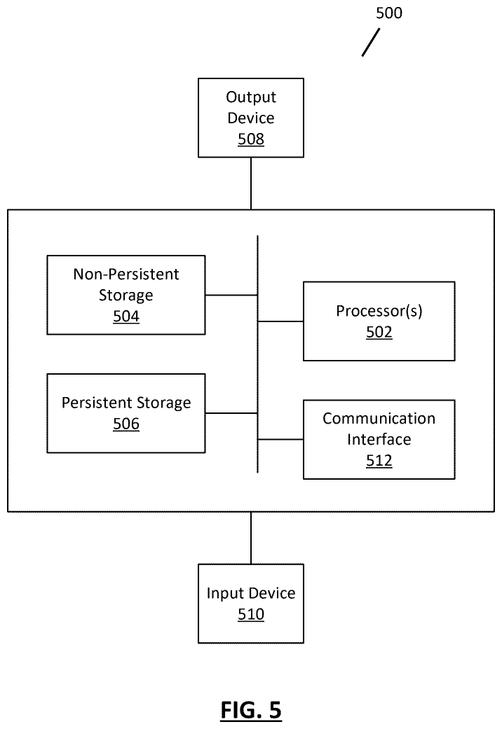

As an example, the cloud infrastructure provider tool 104 may be a computing device. In one or more examples, as used herein, a computing device may be any single computing device, a set of computing devices, a portion of one or more computing devices, or any other physical, virtual, and/or logical grouping of computing resources. Other examples of a computing device are shown in FIG. 4 and FIG. 5, and described below. In one or more examples, a computing device, as used herein, may be any device of any type that is configured to host all or any portion of one or more applications, microservices, clustered environment services, storage services, network services, and/or any other computing function, which may include executing instructions, performing operations, executing functions, performing computations, and the like.

In one or more examples, a computing device is any device, portion of a device, or any set of devices capable of electronically processing instructions and may include, but is not limited to, any of the following: one or more processors (e.g. components that include circuitry), memory (e.g., random access memory (RAM)), input and output device(s), non-volatile storage hardware (e.g., solid-state drives (SSDs), persistent memory (Pmem) devices, hard disk drives (HDDs) (not shown)), one or more physical interfaces (e.g., network ports, storage ports), any number of other hardware components (not shown), and/or any combination thereof.

Examples of computing devices include, but are not limited to, a server (e.g., a blade-server in a blade-server chassis, a rack server in a rack, a desktop server, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, any other type of storage device), a network device, a virtual machine, a virtualized computing environment, a logical container (e.g., for one or more applications), a container pod, an Internet of Things (IoT) device, an array of nodes of computing resources, a supercomputing device, a data center or any portion thereof, and/or any other type of computing device. As one of ordinary skill in the art will appreciate, any of the aforementioned examples of computing devices necessarily require at least some hardware components. As an example, a virtual machine, a container, and/or a container pod, when considered as a computing device herein, include, while in operation, the underlying hardware on which the virtual machine, container, and/or a container pod executes.

In one or more examples, the storage and/or memory of a computing device or system of computing devices may be and/or include one or more data repositories for storing any number of data structures storing any amount of data (e.g., information). In one or more examples, a data repository is any type of storage unit and/or device (e.g., a file system, database, collection of tables, random access memory (RAM), hard disk drive, solid state drive, and/or any other storage mechanism or medium) for storing data. Further, the data repository may include multiple different storage units and/or devices. The multiple different storage units and/or devices may or may not be of the same type or located at the same physical location.

In one or more examples, any storage and/or memory of a computing device or system of computing devices may be considered, in whole or in part, as non-transitory computer readable mediums storing software and/or firmware, which, when executed by one or more processors, cause the one or more processors to perform operations (e.g., execution of one or more computer programs) in accordance with one or more examples disclosed herein.

In one or more examples, the cloud infrastructure provider tool 104 is configured to provide any number of APIs and/or UIs (e.g., web-based UIs) for various purposes. In one or more examples, the cloud infrastructure provider tool 104 is configured to provide an API and/or UI that may be used to generate a cloud infrastructure template. In one or more examples, a cloud infrastructure template is a collection of information (e.g., metadata) related to input parameters that IaC code would need to be executed to provision computing infrastructure.

IaC code may be code written in a particular language or format (e.g., Terraform, Ansible, scripting languages, and the like) for provisioning computing infrastructure. IaC code may be used to provision any amount of computing resources within the computing infrastructure 100 as a particular instance of computing infrastructure to be used by an entity seeking computing infrastructure. As an example, IaC code may be used to provision (e.g., configure) servers, networking, storage, software, applications, virtualized environments (including virtual machines), container environments, and the like. IaC code may be stored, for example, in the IaC repository 102. In one or more examples, the IaC repository 102 is any storage device, or collection of storage devices, that are configured to store IaC code, and that is accessible to the cloud infrastructure provider tool 104. As an example, the IaC repository 102 may be a Git repository. As used herein, an IaC repository (e.g., the IaC repository 102) may refer to a single repository for IaC code, or to any number of such repositories. The IaC repository 102 may include any number of files, directories, and the like as part of the IaC code stored therein. In one or more examples, IaC code may be written or otherwise generated by an IaC author, and then stored in the IaC repository 102.

In one or more examples, the cloud infrastructure provider tool 104 may be configured to provide an API and/or a UI that may be used to generate a cloud infrastructure template based on IaC code from the IaC repository 102. In one or more examples, any entity seeking to generate a cloud infrastructure template may access the API and/or UI of the cloud infrastructure provider tool 104 to do so. In one or more examples, cloud infrastructure template generation may be sought so that users seeking to provision computing infrastructure may do so by providing input parameters based on the template, without having to generate IaC code themselves for such provisioning.

When writing IaC code, the entity generating such code (e.g., the author) may decide the format of the IaC (e.g., Terraform, Ansible, and the like), including the format of the input parameters needed to execute the code to provision the computing infrastructure. As an example, the author might decide that the number of nodes to be provisioned should be an integer, and the geographic region in which the nodes should be deployed should be a string. The author may also decide on default values for all or any portion of the input parameters, and which input parameters are required. The author may place constraints on the input parameters, such as, for example, the number of nodes must be between one and ten.

Once IaC code has been generated by an author, and, thus, the input parameters needed have been defined, the IaC code is stored, as discussed above, in an IaC repository (e.g., the IaC repository 102). An entity seeking to generate a cloud infrastructure template based on the IaC code may then interact with the cloud infrastructure provider tool 104 to access an API and/or UI through which a cloud infrastructure template may be generated. Such an API and/or UI may prompt the entity seeking to generate the template to provide one or more paths (e.g., a Uniform Resource Locator (URL)) to the one or more repositories in which the IaC code is stored (e.g., the IaC repository 102), which may include specifying one or more directories of a repository that include the relevant IaC code. Once such a path has been provided, the entity seeking to generate the template may then provide an indication (e.g., hit a button in a web-based UI) to cause generation of the cloud infrastructure template.

To generate a cloud infrastructure template, the cloud infrastructure provider tool may invoke a cloud infrastructure template generator (e.g., the cloud infrastructure template generator 106). In one or more examples, the cloud infrastructure template generator 106 is a computing device (discussed above and below in the description of FIG. 5). In one or more examples, the cloud infrastructure template generator 106 is separate from, and operatively connected to the cloud infrastructure provider tool (e.g., as shown in FIG. 1). In other examples, the cloud infrastructure template generator 106 may be considered part of the cloud infrastructure provider tool 104. In either case, the cloud infrastructure template generator 106 is configured to access the IaC code at the path provided, and to assess (e.g., parse) the IaC code to obtain information related to the input parameters needed to execute the IaC code to provision computing infrastructure. In one or more examples, the cloud infrastructure template generator then automatically generates input parameter metadata for the cloud infrastructure template.

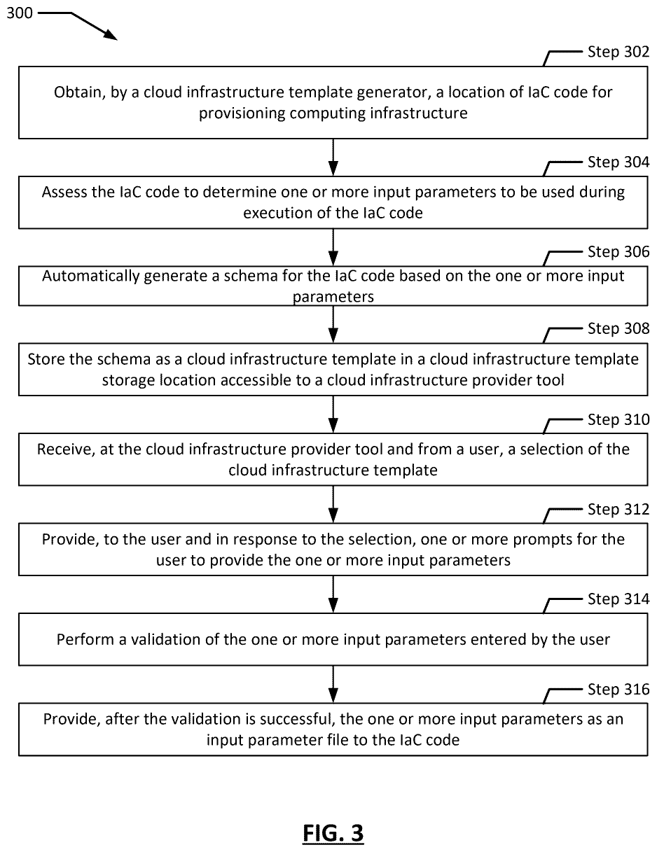

In one or more examples, the input parameter metadata is based on the IaC code in the one or more directories at the path provided. In one or more examples, the input parameter metadata is defined using a schema syntax, such as, for example, a JSON schema syntax. As an example, the cloud infrastructure template generator may execute a library that will programmatically inspect the IaC code input parameters, and generate a JSON schema definition for the input parameters. The schema will then be stored as part of the template in the cloud infrastructure template storage device 108. Generation of the cloud infrastructure template is discussed further in the description of FIG. 3, below.

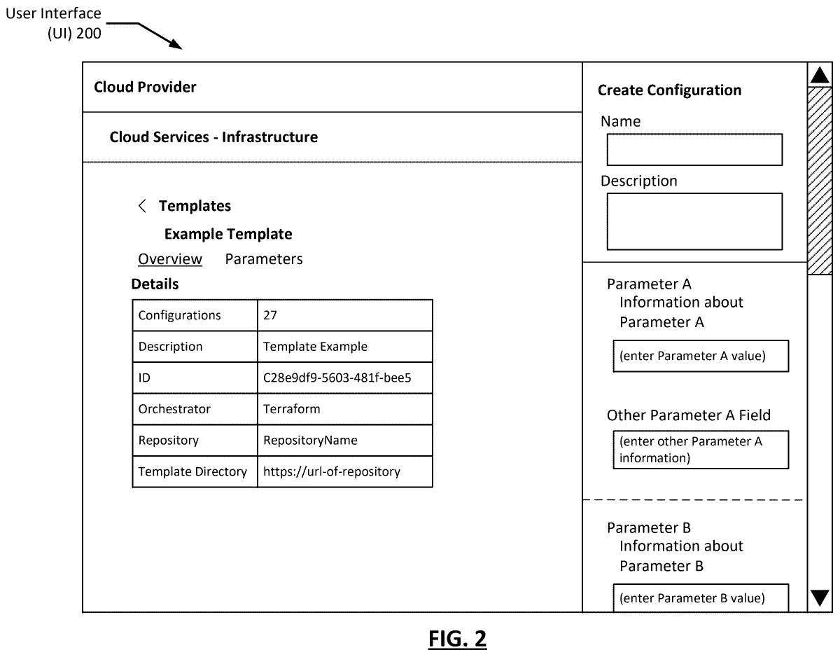

In one or more examples, the cloud infrastructure provider tool 104 is further configured to provide another API and/or UI for users seeking to provision cloud infrastructure. One simple example of such a UI is shown in FIG. 2, and discussed below. In one or more examples, a user may access the API and/or UI provided by the cloud infrastructure provider tool and browse a set of available cloud infrastructure templates (e.g., templates stored in the cloud infrastructure template storage device 108).

In one or more examples, once the user has selected a particular template (e.g., to provision a set of virtual machines, to provision a set of physical devices, to provision a container environment, and the like), the cloud infrastructure provider tool may call an API (e.g., a Representational State Transfer (REST) API) to obtain the schema definition (e.g., JSON schema definition) for the input parameters corresponding to the selected template previously generated by the cloud infrastructure template generator 106. In one or more examples, the cloud infrastructure provider tool will use the schema definition to generate a form for the user to fill in with input parameter information, such as values, types, and the like.

In one or more examples, once a user has entered input parameter information into such a form, a real-time initial validation may be performed on the entered information. As an example, a template for provisioning a number of nodes may have the number of nodes as an input parameter, with the constraint that the number of nodes must be between one and ten. Thus, if a user enters a number outside that range, the user may be provided with an indication (e.g., a pop-up) that indicates that the value entered is an error, and may also include information to allow the user to correct the value (e.g., “The number of nodes must be between 1 and 10”).

In one or more examples, once the user has entered all required input parameters, or accepted default values, where available, for the parameters, the input parameter information may be considered as a specific configuration based on the cloud infrastructure template. In one or more examples, the input parameter information may be collected into a file (e.g., a JSON file), or stored in memory, which may then be provided as input to the IaC code corresponding to the template. In one or more examples, the file is subjected to an additional validation to validate the information related to the input parameters that is included in the file. In one or more examples, once this validation is passed, the IaC code may be executed using the input parameter information as needed to provision computing infrastructure. As an example, the cloud infrastructure provider tool may invoke or otherwise cause the execution of the IaC code to provision computing infrastructure using the input parameter information entered by the user based on the cloud infrastructure template.

While FIG. 1 shows a particular configuration of devices and/or components, other configurations may be used without departing from the scope of examples described herein. As an example, the cloud infrastructure provider tool 104, the IaC repository 102, the cloud infrastructure template generator 106, and/or the cloud infrastructure template storage device may all be part of the same device, or may be implemented via any number of separate and operatively connected devices. Accordingly, examples disclosed herein should not be limited to the configuration of devices and/or components shown in FIG. 1.

FIG. 2 shows an example of a web-based UI 200 generated based on a cloud infrastructure template in accordance with one or more examples disclosed herein. In the example of FIG. 2, IaC code has been generated for provisioning computing infrastructure. The author of the IaC code, in this hypothetical example, then accessed a cloud infrastructure provider tool (e.g., the cloud infrastructure provider tool 104 of FIG. 1) to generate a cloud infrastructure template corresponding to the IaC code. The author provided a path to the IaC code stored in an IaC repository (e.g., the IaC repository 102 of FIG. 1), and initiated generation of the cloud infrastructure template. The cloud infrastructure provider tool invoked a cloud infrastructure template generator (e.g., the cloud infrastructure template generator 106 of FIG. 1) to generate a cloud infrastructure template for the IaC code at the provided path.

The cloud infrastructure template generator, in this example, parsed the IaC code to obtain input parameter metadata and generate a JSON schema corresponding to the input parameters needed to execute the IaC code. The schema was stored as part of the cloud infrastructure template corresponding to the IaC code in a cloud infrastructure template storage device (e.g., the cloud infrastructure template storage device 108 of FIG. 1).

Continuing the example, a user accessed a web-based UI 200 of the cloud infrastructure provider tool to provision computing infrastructure, and selected a template, called ‘Example Template’ in FIG. 2. In response to the selection, the UI 200 displayed an overview of details related to the template (e.g., number of configurations for which the template was used, a template description, a template ID, the name of an IaC tool corresponding to the IaC code on which the template is based, the name of the repository of the IaC code and a corresponding directory). The UI 200 also then uses the JSON schema of the cloud infrastructure template to render a form, shown in the right hand side of FIG. 2, in which the user is prompted to enter information, including input parameter information. In this example, the user is prompted to enter a name for the configuration of computing infrastructure being provisioned, and an optional description of the same. The user is also prompted to enter input parameter information, such as input parameter values, and other information related to input parameters. Although not shown in FIG. 2, the user may be prompted to enter information related to input parameters in other ways, such as via selection of a value from a drop-down menu when the input parameter should be one of a particular set of values, by selecting a ‘+’ or ‘add’ button to add input parameter values when the input parameter is a list type, and/or any other relevant UI technique for prompting a user to enter information.

In one or more examples, once a user enters the input parameter information via the form shown in the web-based UI 200 shown in FIG. 2, the input parameter information may be collected into a file, subjected to any additional validation of the input parameters (e.g., relative to expected values, types, and the like), and used as input for the IaC code to provision computing infrastructure.

While FIG. 2 shows a particular simplified example of a web-based UI rendered based on a cloud infrastructure template, examples disclosed herein should not be limited to such an example. In some examples, the UI may appear differently. In other examples, a user may interact with an API rather than a GUI. Other forms of UIs based on a cloud infrastructure template may be used without departing from the scope of examples disclosed herein.

FIG. 3 illustrates an overview of an example method for automatically generating a schema for a cloud infrastructure template based on IaC code, in accordance with to one or more examples disclosed herein.

The method 300 may be performed, at least in part, by one or more devices and/or components of the system of FIG. 1. As such, all or any portion of the method 300 may be performed, for example, by a cloud infrastructure provider tool (e.g., the cloud infrastructure provider tool 104 of FIG. 1) and/or a cloud infrastructure template generator (e.g., the cloud infrastructure template generator 106 of FIG. 1).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3 and/or steps not shown in FIG. 3.

In Step 302, the method 300 includes obtaining, by a cloud infrastructure template generator (e.g., the cloud infrastructure template generator 106 of FIG. 1), a location of Infrastructure-as-Code (IaC) code for provisioning computing infrastructure. In one or more examples, IaC code for provisioning computing infrastructure may be stored, for example, in one or more directories of an IaC repository (e.g., the IaC repository 102 of FIG. 1).

The IaC code may be generated by an IaC code author, or any other entity. The IaC code may be for provisioning computing resources of any type and/or amount as computing infrastructure. As an example, the IaC code may be for provisioning computing infrastructure for a user of an IaC service of a cloud infrastructure provider. In one or more examples, a location of the IaC code may be any representation of information that indicates where the IaC code is stored (e.g., a URL, a directory, a file path, a file name, any other path representation, and/or any combination thereof).

In one or more examples, the location of the IaC code may be provided by any entity seeking to generate a cloud infrastructure template corresponding to the IaC code. As an example, an entity may access an API and/or UI of a cloud infrastructure provider tool (e.g., the cloud infrastructure provider tool 104 of FIG. 1), and provide the location of the IaC code. In one or more examples, although not shown in FIG. 3, a cloud infrastructure template generator may be configured to monitor one or more IaC repositories, and thus become aware of new or updated IaC code as it is added or updated within the one or more IaC repositories, and obtain the corresponding location of the new or updated IaC code.

Additionally, although not shown in FIG. 1, an entity may also provide an indication to the cloud infrastructure provider tool to cause generation of a cloud infrastructure template based on the IaC code, which may cause the cloud infrastructure provider tool to invoke, initiate, or otherwise access the cloud infrastructure template generator, and to provide the location of the IaC code thereto.

In Step 304, the method 300 includes assessing, by the cloud infrastructure template generator (e.g., the cloud infrastructure template generator 106 of FIG. 1), the IaC code to determine one or more input parameters to be used during execution of the IaC code. Assessing the IaC code may include, for example, parsing sections of the IaC code, identifying input parameters, converting the input parameters and related information into properties within a schema (e.g., a JSON schema). The schema may generally follow the structures defined in the IaC code. Any type information, input variable description, indication of whether an input parameter is nullable, default values, and the like may be obtained as metadata associated with the input parameters.

In Step 306, the method 300 includes automatically generating, by the cloud infrastructure template generator (e.g., the cloud infrastructure template generator 106 of FIG. 1), a schema for the IaC code based on the one or more input parameters. In one or more examples, automatically generating the schema may include using the input parameters and related information obtained in Step 304 to generate the schema. The schema may, for example, be generated in a declarative language that includes the input parameters as properties, and includes constraints and other information related thereto. In one or more examples, such as when more well-defined IaC tools (e.g., Terraform or Ansible) are used to write the IaC code, the schema generation may be entirely automated. In other examples, such as when less well-defined tools are used as IaC code (e.g., a Bash script), the cloud infrastructure template generator may instead generate an initial attempt at the schema for the template. In such a scenario, the initial schema may be provided to the entity that initiated the template generation, and modifications to the initial schema may be made by the entity, with the modifications being used to generate the schema that becomes part of the cloud infrastructure template. In one or more examples, machine learning (ML) and/or artificial intelligence (AI) techniques (e.g., large language models, transformers, and the like) may be used as part of generating the schema, or an initial attempt at the schema. Such ML/AI techniques may include iteratively training an ML model to generate schema based on IaC code. In one or more examples, output from such an ML model may be modified to correct any errors in the schema, and the modifications may be iteratively incorporated into training data to perform on-going training of such ML models to generate the schema.

In Step 308, the method 300 includes storing the schema as at least a portion of a cloud infrastructure template in a cloud infrastructure template storage location (e.g., the cloud infrastructure template storage device 108 of FIG. 1) accessible to a cloud infrastructure provider tool (e.g., the cloud infrastructure provider tool 104 of FIG. 1). In one or more examples, storing the schema as a cloud infrastructure template may include identifying a storage location within a cloud infrastructure template storage device, naming the template (if not already named), generating an identifier for the template, and storing these items of information, along with the schema, in a particular storage location accessible by the cloud infrastructure provider tool.

In Step 310, the method 300 includes receiving, at the cloud infrastructure provider tool (e.g., the cloud infrastructure provider tool 104 of FIG. 1) and from a user, a selection of the cloud infrastructure template. In one or more examples, a user may access an API and/or UI (e.g., the web-based UI 200 of FIG. 2) provided by the cloud infrastructure provider tool, navigate to a set of available cloud infrastructure templates, and select the cloud infrastructure template that best suits the need of the user (e.g., is for provisioning appropriate computing infrastructure).

In Step 312, the method 300 includes providing, to the user and in response to the selection, one or more prompts for the user to provide the one or more input parameters. In one or more examples, the API and/or UI may provide information related to the selected cloud infrastructure template, such as an overview of information about the template, a listing of the input parameters associated with the template, and the like. The API and/or UI may also generate and display a form for the user that includes the prompts (e.g., fields and information related thereto) for the input parameters. The form may request the user to enter a name for a configuration of comprising infrastructure to be provisioned using the template, a description of the same, and information related to the input parameters, such as a value for the input parameter, any relevant type information corresponding to the parameter, and any other information needed as part of the input parameter so that the input parameter may be successfully provided to the IaC code associated with the cloud infrastructure template to provision computing infrastructure.

In Step 314, the method 300 includes performing a validation of the one or more input parameters and/or related information entered by the user. In one or more examples, the validation may be performed for each input parameter, or any portion thereof. In one or more examples, the validation may be an initial validation performed in real time or near real time as the input parameter information is being entered by the user. In one or more examples, the validation may be performed, at least in part, based on constraints and/or other information associated with an input parameter in the schema generated based in the IaC code as part of the cloud infrastructure template. In one or more examples, although not shown in FIG. 3, if a validation fails, the user may be informed of the failure, and may be provided information that may assist the user in correcting any error causing the failed validation. As an example, IaC code for provisioning a container ecosystem may require, as an input parameter, a number of nodes to be used, with the number of nodes required to be between one and twenty nodes. A JSON schema generated as part of a cloud infrastructure template based on such IaC code may include the number of nodes input parameter, and the constraint that the number of nodes entered must be between one and twenty, entered as numerals. In such a scenario, if a user enters anything into a field for the number of nodes that is anything other than a numeral between one and twenty, the user may be provided with a pop up dialogue bubble that indicates that the value entered by the user is invalid, and may inform the user that the value needs to be a number between 1 and 20.

In Step 316, the method 300 includes providing, after the validation is successful, the one or more input parameters as an input parameter file to the IaC code. In one or more examples, the various entries related to the input parameters provided by the user in Step 312, after a successful validation thereof in Step 314, may be collected into a file (e.g., a JSON file), which may then be provided as input for the IaC code. Although not shown in FIG. 3, the information in the file may be subjected to additional validation to ensure it conforms with how input parameter information is expected by the IaC code when executed. In one or more examples, the IaC code may then be executed, using the input parameter information from the file, to provision computing infrastructure.

FIG. 4 illustrates a block diagram of a computing device 400, in accordance with one or more examples disclosed herein. The computing device 400 is an example of the various computing devices (e.g., the cloud infrastructure provider tool 104, the cloud infrastructure template generator 106 of FIG. 1) described above and/or of the computing device 500, described below. As discussed above in the descriptions of FIG. 1, FIG. 2, and FIG. 3, the computing device 400 may be used to implement all or any portion of the various components shown in FIG. 1 and described above.

The computing device 400 may include one or more processors 402 and memory 404. The memory 404 may include a non-transitory computer-readable medium that stores programming for execution by one or more of the one or more processors 402. In this implementation, one or more modules within the computing device 400 may be partially or wholly embodied as software for performing any functionality described in this disclosure. The computing device 400 may be, for example, configured to perform the method shown in FIG. 3 and described above, by executing instructions included in the memory 404 and executed by the one or more processors 402.

For example, the memory 404 may include instructions 406 to obtain, by a cloud infrastructure template generator, a location of IaC code for provisioning computing infrastructure (e.g., as described above in reference to Step 302 of FIG. 3).

For example, the memory 404 may include instructions 408 to assess the IaC code to determine one or more input parameters to be used during execution of the IaC code (e.g., as described above in reference to Step 304 of FIG. 3).

For example, the memory 404 may include instructions 410 to automatically generate a schema for the IaC code based on the one or more input parameters (e.g., as described above in reference to Step 306 of FIG. 3).

For example, the memory 404 may include instructions 412 to store the schema as a cloud infrastructure template in a cloud infrastructure template storage location accessible to a cloud infrastructure provider tool (e.g., as described above in reference to Step 308 of FIG. 3).

For example, the memory 404 may include instructions 414 to receive, at the cloud infrastructure provider tool and from a user, a selection of the cloud infrastructure template (e.g., as described above in reference to Step 310 of FIG. 3).

For example, the memory 404 may include instructions 416 to provide, to the user and in response to the selection, one or more prompts for the user to provide the one or more input parameters (e.g., as described above in reference to Step 312 of FIG. 3).

For example, the memory 404 may include instructions 418 to perform a validation of the one or more input parameters entered by the user (e.g., as described above in reference to Step 314 of FIG. 3).

For example, the memory 404 may include instructions 420 to provide, after the validation is successful, the one or more input parameters as an input parameter file to the IaC code (e.g., as described above in reference to Step 316 of FIG. 3).

FIG. 5 illustrates a block diagram of a computing device, in accordance with one or more examples of this disclosure. As discussed above, examples described herein may be implemented using computing devices, and the computing device 500 shown in FIG. 5 may be such a computing device. For example, all or any portion of the components shown in FIG. 1 (e.g., portions of the computing infrastructure 100, the cloud infrastructure provider tool 104, the cloud infrastructure template generator 106) may be implemented, at least in part using a computing device such as the computing device 500, and may include all or any portion of the components of the computing device 500 shown in FIG. 5 and described below. Additionally, all or any portion of the method shown in FIG. 3 may be performed using one or more computing devices, such as the computing device 500.

In one or more examples, a computing device (e.g., the computing device 500) is any device, portion of a device, or any set of devices capable of electronically processing instructions and may include, but is not limited to, any of the following: one or more processors (e.g. components that include circuitry) (e.g., the processor 502), memory (e.g., random access memory (RAM)) (not shown), input and output device(s) (e.g., the non-persistent storage 506), non-volatile storage hardware (e.g., solid-state drives (SSDs), persistent memory (Pmem) devices, hard disk drives (HDDs) (not shown)), one or more physical interfaces (e.g., network ports, storage ports) (e.g., the persistent storage 506), any number of other hardware components (not shown), and/or any combination thereof. As used herein, a processor may be any component that can be configured to execute operations, processes, threads, and the like. In some examples, a computing device (e.g., the computing device 500) may include any number of heterogeneous processors.

The computing device 500 may include a communication interface 512 (e.g., Bluetooth interface, infrared interface, network interface, optical interface, any other type of communication interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be a central processing unit (CPU), a multi-core CPU, an application specific integrated circuit (ASIC), a graphics processing unit (GPU), a data processing unit (DPU), a tensor processing units (TPU), an associative processing unit (APU), a vision processing units (VPU), a quantum processing unit (QPU), and/or various other processing units that use special purpose hardware (e.g., field programmable gate arrays (FPGAs), System-on-a-Chips (SOCs), digital signal processors (DSPs)). Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, CAMs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

The specific details provided in the description above are intended to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not included in a drawing. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. A system, comprising:
one or more processors; and
one or more non-transitory computer readable media storing instructions which, when executed by the one or more processors, cause the one or more processors to:
obtain, by a cloud infrastructure template generator, a location of Infrastructure-as-Code (IaC) code for provisioning computing infrastructure;
assess, by the cloud infrastructure template generator, the IaC code to determine whether the IaC code includes any input parameters to be used during execution of the IaC code;
automatically generate, by the cloud infrastructure template generator and when one or more input parameters exist, a schema for the IaC code based on the one or more input parameters;
store the schema as a portion of a cloud infrastructure template in a cloud infrastructure template storage location accessible to a cloud infrastructure provider tool;
receive, at the cloud infrastructure provider tool and from a user, a selection of the cloud infrastructure template;
provide, to the user and in response to the selection, one or more prompts for the user to provide the one or more input parameters;
perform a validation of the one or more input parameters entered by the user; and
provide, after the validation is successful, the one or more input parameters to the IaC code,
wherein the IaC code is executed using the one or more input parameters to provision the computing infrastructure for the user.

2. The system of claim 1, wherein, when the validation is not successful, the instructions further cause the one or more processors to:
provide an alert to the user,
wherein the alert comprises an indication of why the validation was not successful.

3. The system of claim 1, wherein the schema is a JavaScript Object Notation (JSON) schema.

4. The system of claim 1, wherein the cloud infrastructure provider tool comprises one or more application programming interfaces (APIs) or one or more graphical user interfaces (GUIs).

5. The system of claim 1, wherein the location of the IaC code comprises multiple IaC directories.

6. The system of claim 1, wherein the one or more prompts are provided to the user as part of a form generated based on the schema.

7. The system of claim 1, wherein the instructions further cause the one or more processors to, before storing the schema as the portion of the cloud infrastructure template:
provide a proposed schema to a template author;
receive one or more modifications to the proposed schema from the template author; and
generate the schema as at least a portion of the cloud infrastructure template based at least in part on the one or more modifications.

8. A computer-implemented method, comprising:
obtaining, by a cloud infrastructure template generator, a location of Infrastructure-as-Code (IaC) code for provisioning computing infrastructure;
assessing, by the cloud infrastructure template generator, the IaC code to determine whether the IaC code includes any input parameters to be used during execution of the IaC code;
automatically generating, by the cloud infrastructure template generator and when one or more input parameters exist, a schema for the IaC code based on the one or more input parameters;
storing the schema as a portion of a cloud infrastructure template in a cloud infrastructure template storage location accessible to a cloud infrastructure provider tool;
receiving, at the cloud infrastructure provider tool and from a user, a selection of the cloud infrastructure template;
providing, to the user and in response to the selection, one or more prompts for the user to provide the one or more input parameters;
performing a validation of the one or more input parameters entered by the user; and
providing, after the validation is successful, the one or more input parameters to the IaC code,
wherein the IaC code is executed using the one or more input parameters to provision the computing infrastructure for the user.

9. The computer-implemented method of claim 8, wherein, when the validation is not successful, the computer-implemented method further comprises:
providing an alert to the user,
wherein the alert comprises an indication of why the validation was not successful.

10. The computer-implemented method of claim 8, wherein the schema is a JavaScript Object Notation (JSON) schema.

11. The computer-implemented method of claim 8, wherein the cloud infrastructure provider tool comprises one or more application programming interfaces (APIs) or one or more graphical user interfaces (GUIs).

12. The computer-implemented method of claim 8, wherein the location of the IaC code comprises multiple IaC directories.

13. The computer-implemented method of claim 8, wherein the one or more prompts are provided to the user as part of a form generated based on the schema.

14. The computer-implemented method of claim 8, further comprising, before storing the schema as the portion of the cloud infrastructure template:
providing a proposed schema to a template author;
receiving one or more modifications to the proposed schema from the template author; and
generating the schema as at least a portion of the cloud infrastructure template based at least in part on the one or more modifications.

15. A non-transitory computer-readable medium storing programming for execution by one or more processors, the programming comprising instructions to:
obtain, by a cloud infrastructure template generator, a location of Infrastructure-as-Code (IaC) code for provisioning computing infrastructure;
assess, by the cloud infrastructure template generator, the IaC code to determine whether the IaC code includes any input parameters to be used during execution of the IaC code;
automatically generate, by the cloud infrastructure template generator and when one or more input parameters exist, a schema for the IaC code based on the one or more input parameters;
store the schema as a cloud infrastructure template in a cloud infrastructure template storage location accessible to a cloud infrastructure provider tool;
receive, at the cloud infrastructure provider tool and from a user, a selection of the cloud infrastructure template;
provide, to the user and in response to the selection, one or more prompts for the user to provide the one or more input parameters;
perform a validation of the one or more input parameters entered by the user; and
provide, after the validation is successful, the one or more input parameters to the IaC code,
wherein the IaC code is executed using the one or more input parameters to provision the computing infrastructure for the user.

16. The non-transitory computer-readable medium of claim 15, wherein the programming comprises further instructions, when the validation is not successful, to:
provide an alert to the user,
wherein the alert comprises an indication of why the validation was not successful.

17. The non-transitory computer-readable medium of claim 15, wherein the cloud infrastructure provider tool comprises one or more application programming interfaces (APIs) or one or more graphical user interfaces (GUIs).

18. The non-transitory computer-readable medium of claim 15, wherein the location of the IaC code comprises multiple IaC directories.

19. The non-transitory computer-readable medium of claim 15, wherein the one or more prompts are provided to the user as part of a form generated based on the schema.

20. The non-transitory computer-readable medium of claim 15, wherein the programming further comprises instructions to, before storing the schema as the portion of the cloud infrastructure template:
provide a proposed schema to a template author;
receive one or more modifications to the proposed schema from the template author; and
generate the schema as at least a portion of the cloud infrastructure template based at least in part on the one or more modifications.
